(19) United States
(12) Patent Application Publication
(10) Pub. No.: US 2017/0061363 A1
(43) Pub. Date: Mar. 2, 2017

(54) METHOD AND SYSTEM FOR ENHANCING A SALES TEAM DATABASE

(71) Applicants: Vincent M. Roazzi, SR., New Hope, PA (US); Jessica Magoch, New Hope, PA (US)

(72) Inventors: Vincent M. Roazzi, SR., New Hope, PA (US); Jessica Magoch, New Hope, PA (US)

(21) Appl. No.: 14/835,020

(22) Filed: Aug. 25, 2015

(51) Int. Cl. G06Q 10/06

(52) U.S. Cl. CPC G06Q 10/063118

(57) ABSTRACT

Systems and methods are disclosed which are useful in an outsourced sales team that is offering commission based sales. Systems may include a database of potential clients with a client revenue goal for each of the potential clients. The data may include a set of parameters related to the client revenue goal for each of the potential clients. A computer processor may be controlled by the outsourced sales team, and may be coupled to the database and programmed to receive from a user of a computer a selection of a first client that is a potential client. The computer processor may automatically determine a total investment projection, which is an estimated investment needed to reach the client revenue goal, based on the client revenue goal and the set of parameters.

### BACKGROUND

1. Technical Field

This disclosure relates to systems and methods of enhancing a sales team database.

2. Background Art

Sales Team Databases are known but they do not address the needs of outsourced sales force services for start-up businesses. There is currently a need in the art for an outsourced solution for new and cash-strapped companies to recruit, train, manage an effective (commission-only) sales force given the high cost of sales and the lead time necessary before leads and sales become cash into the business.

### BRIEF SUMMARY

Systems and methods are disclosed which are useful in an outsourced sales team that is offering commission based sales. Systems may include a database of potential clients with a client revenue goal for each of the potential clients. The data may include a set of parameters related to the client revenue goal for each of the potential clients. A computer processor may be controlled by the outsourced sales team, and may be coupled to the database and programmed to receive from a user of a computer a selection of a first client that is a potential client. The computer processor may automatically determine a total investment projection, which is an estimated investment needed to reach the client revenue goal, based on the client revenue goal and the set of parameters.

Systems and methods are disclosed that may be used for calculating an investment amount needed for an outsourced sales team to achieve a revenue goal within a set time period. Systems may include a computer database connected to a communication system, and a computer with a display and a processor connected to the communication system.

The processor may be programmed to receive client input related to a client revenue goal and store the client input in a first memory location in the computer database. The processor may receive a selection of a set of parameters related to the client revenue goal and store the set of parameters in a second memory location in the computer database associated with the client input. The processor may automatically transform the set of parameters and the client input to produce a sales projection and store the sales projection in a third memory location in the computer database associated with the client input. The processor may automatically transform the sales projection and the client input to produce a commission projection and store the commission projection in a fourth memory location in the computer database associated with the client input. The processor may automatically transform the commission projection and the sales projection to produce a total investment projection and store the total investment projection in a fifth memory location in the computer database associated with the client input. The processor may automatically transform the client revenue goal including the total investment projection to produce a computer-generated model for creation of the outsourced sales team and store the computer-generated model in a sixth memory location in the computer database associated with the client input. The processor may transmit to the display a visual representation of the computer-generated model.

### BRIEF DESCRIPTION OF THE DRAWINGS

FIG. 1 shows a representation of a computer coupled to a database according to some embodiments.

FIG. 2 illustrates an example system for enhancing a sales team database according to some embodiments.

### DETAILED DESCRIPTION

The problem of evaluating whether a company or product presents a viable opportunity for a commission-only salesforce model, and identifying which opportunities are better than others, is solved by some embodiments disclosed, including a software-enabled system that efficiently collects specific relevant data, quantifies it, transforms the relevant data, and outputs a viability score.

In some embodiments a system may identify viable opportunities and transform data to produce a proposal that outlines the manner in which allows an outsourced sales company may profitably recruit, train, manage, motivate and reward a sales force designed around the particular start-up's products and services on a commission-only or commission and equity basis. This may allow the outsourced sales company to pre-qualify opportunities and identify an appropriate commission and equity package as well as the investment that the applicant would be required to invest, in order to accomplish the clients' sales objectives, and identify appropriate commissions and equity percentages.

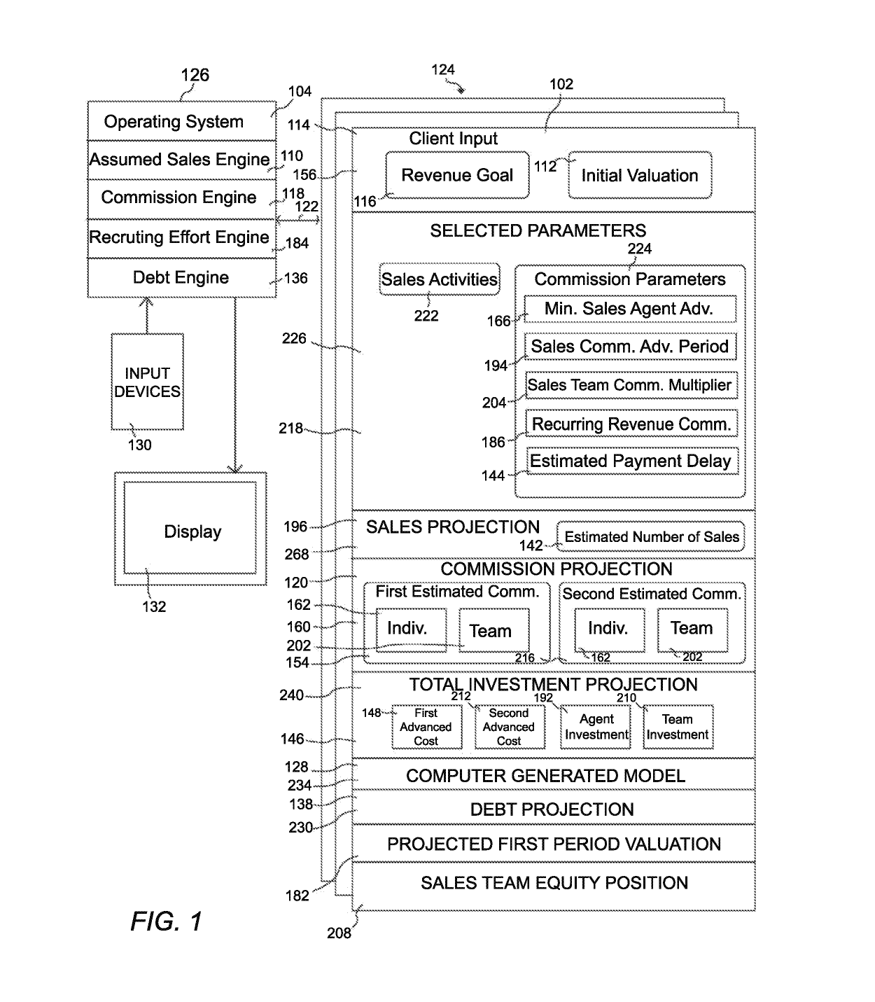

FIG. 1 shows a representation of a computer coupled to a database 124, which may be a sales team database 124 according to some embodiments. The computer may include a processor 126 with an operating system 104, input devices 130 including keyboard, mouse, speaker, touch screen, or other forms of input devices 130. The computer may also include output devices 132 including a display, speakers, printers, or other output devices 132. The processor 126 may be connected to the database 124 through a communication system 122, which may include a communication bus, a computer network and other systems and devices for communicating between a processor 126 and a database 124. Input devices 130 may be connected through other computers or a network system or communication system 122.

In some embodiments the database 124 includes client input 114 stored in a first memory location 156. The client input 114 may be received through an input device 130 and received by processor 126. Client input 114 may include a revenue goal 116 that may be based on desired revenue achieved within a set time period. Client input 114 may be related to a client revenue goal 116. The inputs may be entered by the client or by the outsourced sales team. The client input 114 may include an initial valuation 112 of the client's business for which the outsourced sales team will be performing sales.

The database 124 may store selected parameters 226 in a second memory location 218. The selected parameters 226 may include sales activities 222 that are selected, including but not limited to cold calling, internet generated leads, referrals, and other sales activities. The selected sales activities 222 may include an anticipated number of the activity, including but not limited to a specified number of cold calls within a time period, and an anticipated conversion rate for the activity. In some embodiments the processor 126, with the assumed sales engine 110 may determine a conversion rate based on anticipated steps and their individual conversion rates. The assumed sales engine 110 may determine an anticipated number of appointments set when the sales activity is cold calling, and also an anticipated number of appointments kept, and anticipated number of order commitments, and an anticipated number of final sales. The assumed sales engine 110 may also determine an anticipated number of retained customers when the item sold includes recurring revenue or renewals.

The assumed sales engine 110 may produce a sales projection 196, which may be stored in a third memory location 268. The sales projection 196 may include an estimated number of sales 142. The estimated number of sales 142 may be the sales from one sales agent during a time period, which may be one week, based on the sales activity selected.

In some embodiments a commission engine 118 may produce a commission projection 120, which may be stored in a fourth memory location 160. Commission parameters 224 may be used by the commission engine 118 in determining the commission projection 120. Commission parameters 224 may include a minimum sales agent advance 166, which may be a minimum amount of money to be paid to a sales agent as an advance towards sales commission pay. The minimum sales agent advance 166 may be the advance that is paid to the sales agent within a time period, such as one week.

The commission parameters 224 may include a sales commission advance period 194, which may be the anticipated period during which a sales person will need to be advanced funds before payment from sales will allow the sales agent to be paid fully on commission without an advance. Commission parameters 224 may include a sales team commission multiplier 204. The sales team commission multiplier 204 may be a multiplier based on the commission paid to a sales agent, to determine the amount needed for the sales team. The multiplier may be used to determine the amount needed to cover expenses including management, overhead and profit.

Commission parameters 224 may include a recurring revenue commission 186, which may be a percentage of commission for recurring revenue. In some embodiments revenue from a subscription product may have recurring revenue that occurs in a second year or on a renewal basis. In some embodiments the recurring revenue commission 186 may be less than commission on new customers.

Commission parameters 224 may include an estimated payment delay period 144, which may be a period of time between when a sale is finalized to when payment is available in an account of the sales team.

The commission parameters 224 may be used by commission engine 118 to determine a first estimated commission 154 for a first time period, which may be a first year. The first estimated commission 154 may include an individual commission 162 for an individual sales person, and a sales team commission 202 for the sales team. A second estimated commission 216 may be determined for a second time period, which may be a second year. The second estimated commission 216 may include an individual commission 162 and a team commission 202.

In some embodiments the commission parameters 224 may include a client payment, which may be a payment from the client on a monthly basis, or an annual fee, or an average monthly order. The commission parameters 224 may include a set-up fee to be collected by the sales team from the client when the account is first set-up. The commission engine 118 may also determine an advanced risk period, which may be the sales commission advance period 194 added with the estimated payment delay 144.

In some embodiments a recruiting effort engine 184 determines advanced costs for hiring, training, and managing a sales team as a total investment projection 240. The total investment projection 240 may be stored in a fifth memory location 146. The recruiting effort engine 184 may determine a first advanced cost 148 that may be for a first period of time, which may be a first year. A second advanced cost 212 may also be determined for a second year. Additional advanced costs may also be determined for additional years. Advanced costs may be based on revenue goals 116, and the estimated number sales needed to reach those revenue goals 116. The estimated number of sales needed may be used to determine the estimated number of sales people needed. When the estimated number of sales people is known, costs per sales person may be determined by the recruiting effort engine 184. Costs may include costs that a sales person or agent may have which may be an agent investment 192, and costs that may be incurred by the sales team, which may be a team investment 210. Agent investment 192 may include taxes, travel expenses, benefits (including health or retirement), insurance, and other expenses that are related to a single sales person. Team investment 210 may include recruiting costs, support and management salary, agent advances, office space, training costs, support tools and subscriptions, marketing costs (advertising and other marketing activities), incentives and bonuses, and other costs of recruiting, training and managing a sales team.

In some embodiments a debt engine 136 may use information related to the client input 114, the selected parameters 226, the sales projection 196, the commission projection 120, and the total investment projection 240 to determine a debt projection 138 which may be stored in a seventh memory location 230. The debt projection 138 may determine the projected debt required to support a sales team, with the costs of the sales team compared against the revenue paid in commissions and fees to the sales team.

The debt projection 138 may enable a display on a month by month basis (or other time periods) of the debt position of the sales team, and may identify a specific future month or other time period where the cumulative comparison of projected costs and revenue show greater revenue than costs. The month or other period may be called a break even month, where the amount invested in the sales project for the client is approximately equal to the commissions paid to the sales team for the project. A break even month may be a projected month where the amount invested in the sale project is expected to be less than the commissions paid to the sales team for the project.

The debt engine 136 may calculate and display projected net revenue for the projected time periods based on the investment required to meet multiple sales goals for the multiple time periods. Revenue goals 116 may be selected for each of five future years, and the costs for a sales team may be calculated for each of those five years. The projected revenue to the sales team may also be calculated for each of those five years. As an example, a sales revenue goal 116 for a start-up company may be one-million dollars in sales in the first year, and then doubling revenues each year for the next four years, so that revenue goal 116 for year two would be two-million dollars, for year three, four-million dollars, for year four, eight-million dollars, and for year five sixteen-million dollars. In this example scenario the sales team may require additional expense to increase the size of the sales team each year. The debt engine 136 may calculate the projected costs in each month of the five years for recruiting, training, and supporting a sales team. The revenue from anticipated sales may also be calculated on a month by month basis over the five year period, and with a cumulative comparison, one or more break even points may be identified, and the required investment on a monthly basis may also be determined and displayed.

In some embodiments the processor 126 may transform the data stored in the sales team database 124, to produce a computer generated model 128, which may be stored in a sixth memory location 234. The computer generated model 128 may display the projected new sales for multiple years, as well as projected investment required for the sales team to achieve the projected new sales. The investment may be separated into a sales team investment 210 and the individual sales person investment for all of the sales people anticipated in the time period, and may be a combined investment.

The inputs including the revenue goals 116, initial valuation 112, selected parameters 226, and other inputs may be modified after the processor 126 produces the computer generated model 128, and a new computer generated model 128 may be produced and stored based on changes. This may allow an efficient and accurate manner for an outsourced sales team and a client to determine a sales plan and compensation for the sales team.

In some embodiments the processor 126 produces a projected first period valuation 182, and a sales team equity position 208 and stores them in the sales team database 124. The projected first period valuation 182 may be an anticipated valuation of the client's company when the revenue goal 116 is met for the first time period. The first time period in an example may be a first year, and the projected valuation of the company at the end of the first year may be the projected first period valuation 182. The processor 126 may produce projected valuations for subsequent periods, including a second year, third year, forth year and fifth year valuation.

The sales team equity position 208 may be a calculation of a proposed percentage equity position that the sales team will receive. The sales team equity position 208 may be related to the risks incurred by the sales team, as well as the projected increase in valuation of the client company based on the increased sales. In some embodiments the computer generated model 128 may include the sales equity position 208.

The sales team database 124 may have multiple client files 102. The selected parameters 226 may include default values that may be applied in one or more of the client files 102.

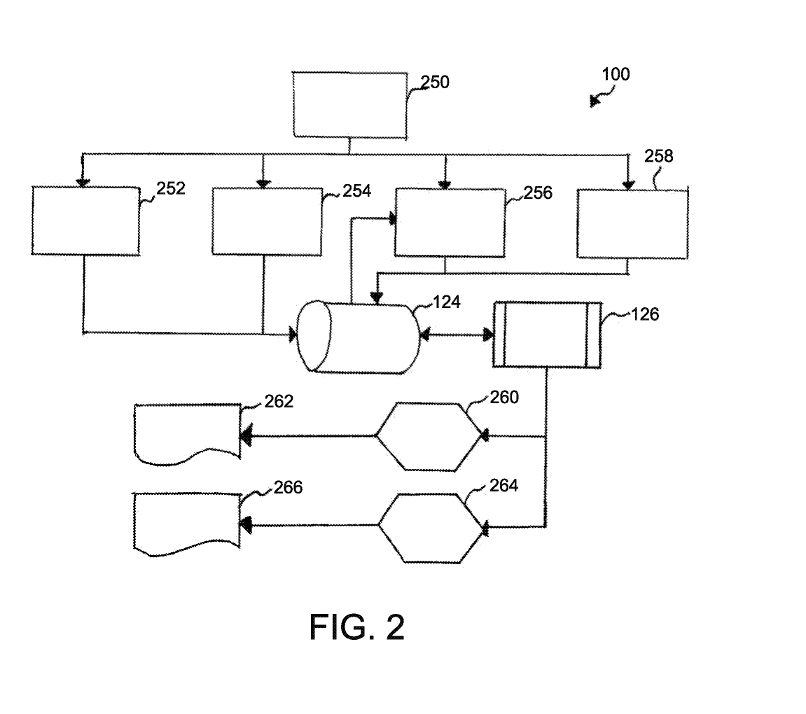

FIG. 2 illustrates an example system 100 according to some embodiments. In some embodiments a system 100 includes a computer processor 126 and database 124. In some embodiments the computer processor 126 is configured to have a login 250 followed by a main menu after successful login. The main menu may display options to view an admin access screen 252, a case listing screen 254, a parameter input screen 256, and a data input screen 258.

The options displayed on the main menu may depend on the level of access associated with the login, or options may be displayed that are disabled with some login IDs. The case listing screen 254 may display specific cases associated with the login used to access the system. One login may show all the cases in the system, including an administrator login, another login may show a group of customer cases based on cases assigned to a group or to an individual in an outsourced sales team. Another login may display cases for specific clients in the case listing screen 254, including if a specific client login was used to access the system.

The case listing screen 254 may be populated from data in the database 124, and in some embodiments the case listing screen 254 allows users to modify the data in the database 124. A case may be selected from the case listing screen 254, and a user may review, input or modify data related to that case.

A user may select to go to a parameter input screen 256 from the main menu. The parameter input screen 256 may be populated with default settings which are stored in the database 124, and a user may modify those values populated by the defaults, or enter data which does not have a default value. In some embodiments, data may be associated with a specific case and some of the data associated with the case may be only accessible by the outsourced sales team. Data entered through the parameter input screen 256 may be stored in the database 124.

A user may also go to a data input screen 258. The data input screen 258 may accept input related to the client. Client data may be associated with more than one case. In some embodiments client data may also be stored in the database 124 and not associated with a case. Client data may also be data associated specifically to one case. Data may be stored in the database 124 prior to all data being entered, and in some embodiments a user may enter a portion of data during one login session, and another portion of data during a second login session.

In some embodiments, processor 126 enhances database 124 by producing sales projections, commission projections, investment projections, debt projections, or a computer generated model 128, which may be stored in the database 124. The sales projections, commission projections, investment projections, debt projections, or a computer generated model 128 may be displayed in a client output screen 260.

Information from the database 124 may be used to produce a client output screen 260 and a sales team output screen 264. In some embodiments the client output screen 260 displays a report 262 and may include a proposal, or allows for download of a report by the client. The report and proposal may present a proposal for the client to work with the outsourced sales team under specific terms. The report 262 or proposal may be an offer, or may be a starting point for negotiation of an offer.

The sales team output screen 264 may display a risk assessment report 266 based on the input related to a specific case. The sales team output screen 264 may include a calculation of risk as a viability score for the client. In some embodiments only a sales team output screen 264 may be displayed, and the output may be limited to a viability score, or may display more information. In some embodiments the sales team output screen 264 displays or allows for download of a different report than the client output screen 260. The sales team output screen 264 may assign risks to the client's case based on the input from the client, and may also display options to adjust the terms of working with the client based on the assigned risks. The output screens 260, 264 may include data entered or used as input data for the case.

In some embodiments the output screens 260, 264 may allow for a user to calculate needed input to achieve a desired output by adjusting one or more of the output data points. In some embodiments a user may adjust one output data point with a resulting change to other data points. If a proposal included financing terms, then changing one aspect of the financing may also change another aspect to compensate. In some embodiments an outsourced sales team may be compensated with equity and commission in a proposal, and a client may adjust the equity in the proposal, which may automatically adjust the commission, or other term and vice versa.

Some or all of the above systems may be useful in methods including computer-implemented methods for enhancing a sales team database 124. Methods may include receiving a client input 114, by a processor 126, related to a client revenue goal 116. The processor 126 may include an assumed sales engine 110, a commission engine 118, and a recruiting effort engine 184. The processor 126 may store the client input 114 in a first memory location 156 in the sales team database 124. Methods may include receiving, at the processor 126, a set of parameters 226 related to the client revenue goal 116, and storing the set of parameters 226 in a second memory location 218 in the sales team database 124 associated with the client input 114.

Methods may include transforming, with the assumed sales engine 110, the set of parameters 226 and the client input 114 to produce a sales projection 196 and storing the sales projection 196 in a third memory location 268 in the sales team database 124 associated with the client input 114. Methods may include transforming, with the commission engine 118, the sales projection 196 and the client input 114 to produce a commission projection 120 and storing the commission projection 120 in a fourth memory location 160 in the sales team database 124 associated with the client input 114.

Methods may include transforming, with the recruiting effort engine 184, the commission projection 120 and the sales projection 196 to produce a total investment projection 240 and storing the total investment projection 240 in a fifth memory location 146 in the sales team database 124 associated with the client input 114. Methods may include transforming, by the processor 126, the client revenue goal 116 and the total investment projection 240 to produce a computer-generated model 128 for a sales team and storing the computer-generated model 128 in a sixth memory location 234 in the sales team database 124 associated with the client input 114.

The processor 126 may include a debt engine 136. Methods may include transforming, with the debt engine 136, the total investment projection 240 and the commission projection 120 to produce a debt projection 138 and storing the debt projection 138 in a seventh memory location 230 in the sales team database 124 associated with the client input 114. Methods may include a debt projection 138 with multiple time periods and a comparison between the total investment projection 240 and the commission projection 120 in the multiple time periods. Methods may include a debt projection 138 with a cumulative comparison between the total investment projection 240 and the commission projection 120 in the multiple time periods. The debt projection 138 may include a determination of one of the multiple time periods where the cumulative comparison shows the commission projection 120 is greater than the total investment projection 240. Methods may include a set of parameters 226 with a selection of one or more sales activities 222 for one or more sales professionals. The sales projection 196 may include an estimated number of sales in a recurring sales time interval. The recurring sales time interval may be one week, and the estimated number of sales may be based on a single full time sales person.

The commission projection 120 may include a first estimated commission 154 paid in a first compensation period. The first estimated commission 154 paid may include an individual sales person commission and a sales team commission 202. The first compensation period may be one year. Methods may include a commission projection 120 with a second estimated commission 216 paid in a second compensation period. The set of parameters may include a set of commission parameters 224 and the commission projection 120 may be produced using the set of commission parameters 224.

Methods may have a set of commission parameters 224 where one or more parameters may be selected from a group consisting of: a minimum sales agent advance 166 amount in a recurring sales time interval; a sales commission advance period 194; a sales team commission multiplier 204; a recurring revenue commission 186 rate; and an estimated payment delay period 144.

Methods may have a total investment projection 240 with a first advanced cost 148 in a first compensation period and a second advanced cost 212 in a second compensation period. The first compensation period may be a first year, and the second compensation period may be a second year.

Methods may include a client input 114 with a client company initial valuation 112. Methods may include transforming, with the processor 126, the client company initial valuation 112 and the client revenue goal 116 to produce a projected first period valuation 182. Methods may include transforming, with the processor 126, the projected first period valuation 182 and the total investment projection 240 to produce a sales team equity position 208.

The total investment projection 240 may include a sales agent investment 192 and a sales team investment 210.

In some embodiments the problem of efficiently and predictably recruiting high-performing sales candidates, specifically the problem of distinguishing high-performers from low-performers, may be solved by a software-enabled system that efficiently collects key-indicator data during the recruitment stage, quantifies it, and transforms the key-indicator data to output a likely-performance score.

The key-indicator data may include observations of behavior and data regarding the actions of the candidate, including but not limited to arrival time at the appointment, whether certain customs in the culture were observed, or the degree that they were observed. Key-indicator data may include measurement of actions that are likely to be performed out of habit by the candidate. In some embodiments key-indicator data may be measured without the knowledge of the candidate.

In some embodiments candidate scoring may be done with a web based application designed to score and evaluate candidates in a sales interview process. In some embodiments a series of interviewer yes/no question responses may be captured and passed through a specifically programmed processor, producing an output report critiquing the candidate's strengths and weaknesses.

Language used in the above summary and detailed description is for the purpose of disclosing various embodiments and is not for the purpose of restrictions on how the invention may be practiced. To this end the word “or” is used above in a non-exclusive meaning, so that where “or” is used one or more of the alternatives may be included. The word “or” is not used in a limiting sense and options are not mutually exclusive unless specifically stated to be mutually exclusive. Similarly, use of singular or plural is not intended to be restrictive and elements that are described in the singular may also be plural, and vice versa.

While the principles of the invention have been made clear in illustrative embodiments, there will be immediately obvious to those skilled in the art many modifications of structure, arrangement, proportions, and methods, the elements, materials, and components used in the practice of the invention, and otherwise, which are particularly adapted to specific environments and operative requirements without departing from those principles. The appended claims are intended to cover and embrace any and all such modifications, within the limits only of the true spirit and scope of the invention.

What is claimed is:

1. A computer-implemented method for enhancing a sales team database comprising:
Receiving a client input, by a processor, related to a client revenue goal, wherein the processor includes an assumed sales engine, a commission engine, and a recruiting effort engine and storing the client input in a first memory location in the sales team database;
Receiving, at the processor, a set of parameters related to the client revenue goal, and storing the set of parameters in a second memory location in the sales team database associated with the client input;
Transforming, with the assumed sales engine, the set of parameters and the client input to produce a sales projection and storing the sales projection in a third memory location in the sales team database associated with the client input;
Transforming, with the commission engine, the sales projection and the client input to produce a commission projection and storing the commission projection in a fourth memory location in the sales team database associated with the client input;
Transforming, with the recruiting effort engine, the commission projection and the sales projection to produce a total investment projection and storing the total investment projection in a fifth memory location in the sales team database associated with the client input; and
Transforming, by the processor, the client revenue goal and the total investment projection to produce a computer-generated model for a sales team and storing the computer-generated model in a sixth memory location in the sales team database associated with the client input.

2. The method of claim 1, wherein the processor further comprises a debt engine and wherein the method further comprises:
Transforming, with the debt engine, the total investment projection and the commission projection to produce a debt projection and storing the debt projection in a seventh memory location in the sales team database associated with the client input.

3. The method of claim 2 wherein the debt projection includes multiple time periods and a comparison between the total investment projection and the commission projection in the multiple time periods.

4. The method of claim 2 wherein the debt projection includes multiple time periods and a cumulative comparison between the total investment projection and the commission projection in the multiple time periods, wherein the debt projection includes a determination of one of the multiple time periods where the cumulative comparison shows the commission projection is greater than the total investment projection.

5. The method of claim 1 wherein the set of parameters include a selection of one or more sales activities for one or more sales professionals.

6. The method of claim 1 wherein the sales projection includes an estimated number of sales in a recurring sales time interval.

7. The method of claim 6 wherein the recurring sales time interval is one week.

8. The method of claim 6 wherein the estimated number of sales is based on a single full time sales person.

9. The method of claim 1 wherein the commission projection includes a first estimated commission paid in a first compensation period.

10. The method of claim 9 wherein the first estimated commission paid includes an individual sales person commission and a sales team commission.

11. The method of claim 9 wherein the first compensation period is one year.

12. The method of claim 9 wherein the commission projection includes a second estimated commission paid in a second compensation period.

13. The method of claim 1 wherein the set of parameters includes a set of commission parameters and wherein the commission projection is produced using the set of commission parameters.

14. The method of claim 13 wherein the set of commission parameters include one or more parameters selected from a group consisting of: a minimum sales agent advance amount in a recurring sales time interval; a sales commission advance period; a sales team commission multiplier; a recurring revenue commission rate; and an estimated payment delay period.

15. The method of claim 1 wherein the total investment projection includes a first advanced cost in a first compensation period and a second advanced cost in a second compensation period.

16. The method of claim 15 wherein the first compensation period is a first year, and wherein the second compensation period is a second year.

17. The method of claim 1 wherein the client input comprises a client company initial valuation, the method further comprising:
Transforming, with the processor, the client company initial valuation and the client revenue goal to produce a projected first period valuation; and
Transforming, with the processor, the projected first period valuation and the total investment projection to produce a sales team equity position.

18. The method of claim 1 wherein the total investment projection includes a sales agent investment and a sales team investment.

19. A system useful in an outsourced sales team that is offering commission based sales, the system comprising:
A database containing data for each of a plurality of potential clients seeking the outsourced sales team, wherein the data includes a client revenue goal for one or more of the plurality of potential clients, and wherein the data includes a set of parameters related to the client revenue goal for the one or more of the plurality of potential clients; and
A computer processor controlled by the outsourced sales team, wherein the computer processor is coupled to the database and programmed to:
Receive from a user of a computer a selection of a first client that is one of the plurality of potential clients;
Automatically determine a total investment projection, which includes an estimated investment needed to reach the client revenue goal, based on the client revenue goal and the set of parameters.

20. A system for calculating an investment amount needed for an outsourced sales team to achieve a revenue goal within a set time period comprising:
A computer database connected to a communication system;
A computer with a display and a processor connected to the communication system, wherein the processor is programmed to:
Receive client input related to a client revenue goal and store the client input in a first memory location in the computer database;
Receive a selection of a set of parameters related to the client revenue goal and store the set of parameters in a second memory location in the computer database associated with the client input;
Automatically transform the set of parameters and the client input to produce a sales projection and store the sales projection in a third memory location in the computer database associated with the client input;
Automatically transform the sales projection and the client input to produce a commission projection and store the commission projection in a fourth memory location in the computer database associated with the client input;
Automatically transform the commission projection and the sales projection to produce a total investment projection and store the total investment projection in a fifth memory location in the computer database associated with the client input;
Automatically transform the client revenue goal including the total investment projection to produce a computer-generated model for creation of the outsourced sales team and store the computer-generated model in a sixth memory location in the computer database associated with the client input; and
Transmit to the display a visual representation of the computer-generated model.
